(19) United States
(12) Patent Application Publication
(10) Pub. No.: US 2009/0188446 A1
(43) Pub. Date: Jul. 30, 2009

(54) Fashion Collar

(75) Inventor: Maya P. Jedlicka, Colleyville, TX (US)

Correspondence Address: The Caldwell Firm, LLC, P.O. Box 59655, Dallas, TX, 75229, US

(73) Assignee: Riyo Pets, LLC, Colleyville, TX (US)

(21) Appl. No.: 12/356,527

(22) Filed: Jan. 20, 2009

Related U.S. Application Data
(60) Provisional application No. 61/024,525, filed on Jan. 29, 2008.

(51) Int. Cl. A01K 27/00

(52) U.S. Cl. 119/858; 119/174

(57) ABSTRACT

A collar comprises a strip of material. A buckle couples to the strip of material. A plurality of attachment ports couple to the strip of material. A fashion attachment comprises a plurality of coupling ports, and each coupling port couples to one of the plurality of attachment ports.

A method for customizing an animal companion collar comprises selecting a first fashion attachment. The first fashion attachment comprises a plurality of coupling ports configured to couple to a plurality of attachment ports of a fashion collar. The method detaches a second fashion attachment from a first fashion collar. The first fashion collar comprises a plurality of attachment ports. The method attaches the first fashion attachment to the first fashion collar by coupling one or more of the plurality of coupling ports to one or more of the plurality of attachment ports.

### TECHNICAL FIELD

The present invention relates generally to the field of fashion and utility apparel and, more particularly, to a system and method for an improved fashion collar.

### BACKGROUND OF THE INVENTION

Certain fashion and utility apparel worn around the neck is generally known as a “collar.” Collars can be configured in a variety of material, and can be functional, fashionable, or both. Collars intended for use by humans are generally mostly fashionable, although some collars also serve a functional purpose. Collars intended for use by or with non-human animals are generally primarily functional, with some collars also fashionable. Collars intended for use by companion animals, such as dogs and cats, for example, are often both functional and fashionable.

Animal collars and restraint aids, such as dog collars, horse harnesses, dog harnesses, and other similar devices, have been known and used for thousands of years. These restraint aids, such as dog collars, are generally utilitarian devices that allow people to manage animals. For example, dog collars allow dog owners, trainers, veterinarians, and others to manage, manipulate, and control a dog as well as provide for the attachment of identification tags, ownership tags, and/or vaccination tags.

Dog collars in particular are often further configured to couple to a leash for the purpose of walking the dog in an unenclosed area, thereby allowing the person to prevent the dog from wandering somewhere where the dog may be injured or lost. A leash and collar configuration also provides a control mechanism to help prevent the dog from jumping onto or biting and injuring another person or animal. Dog collars may be constructed such that they are in the form of a harness, which incorporates material encircling the dog's neck connected by some material to another material encircling the dog's chest or torso. Many other types of dog collars are also available that attach at different parts of the dog's anatomy serving varying utilitarian or aesthetic functions.

Collars generally can be configured in a wide variety of sizes, colors, styles and designs. With respect to companion animals, industry has provided such variety that, for example, a pet owner can find an appropriate dog collar for a dog of any particular size, breed, and temperament in any number of styles and colors. Styles vary from simple to elaborate and may be constructed from a variety of materials such as nylon, leather, or metal chain as well as many other materials.

Most collars, however, are configured in only one color, style, and material. As such, a pet owner that wishes to provide a variety of fashionable collars for her pet must purchase a separate collar for each desired color, style, and/or material. For many pet owners, the cost of multiple collars is cost prohibitive and therefore the pet owner must choose only one of a variety of desired colors, styles, and/or materials. Moreover, even for those limited collars that do provide for some minor customization, transforming between configurations is often difficult and time consuming.

Additionally, when the pet owner wishes to change the pet's attire, conventional collars require that the pet owner remove the first collar to replace it with a new collar in a different style, color, and/or material collar. Furthermore, typical identification tags (ID tags) and proof of vaccination and/or registration tags attach to a collar in such a manner as to make moving the tags from one collar to another very difficult. Thus, if the owner replaces a conventional collar or other restraining device on the animal, the identification tags, vaccination tags, and registration tags must be removed from the previous collar and attached to the new collar. This process also greatly increases the risk that one or both of the new or old collar, or the tags, are damaged or lost.

Therefore, there is a need for an improved fashion collar that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

It is, therefore, one aspect of the present invention to provide for an improved fashion collar.

It is a further aspect of the present invention to provide for an improved fashion collar for companion animals.

It is a further aspect of the present invention to provide for an improved functional fashion collar.

It is a further aspect of the present invention to provide for an improved customizable fashion collar for companion animals, particularly dogs.

The aforementioned aspects and other objectives and advantages can now be achieved as described herein. A collar comprises a strip of material. A buckle couples to the strip of material. A plurality of attachment ports couple to the strip of material. A fashion attachment comprises a plurality of coupling ports, and each coupling port couples to one of the plurality of attachment ports.

In an alternate embodiment, a method for customizing an animal companion collar comprises selecting a first fashion attachment. The first fashion attachment comprises a plurality of coupling ports configured to couple to a plurality of attachment ports of a fashion collar. The method detaches a second fashion attachment from a first fashion collar. The first fashion collar comprises a plurality of attachment ports. The method attaches the first fashion attachment to the first fashion collar by coupling one or more of the plurality of coupling ports to one or more of the plurality of attachment ports.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an improved fashion collar;

FIG. 2 illustrates a block diagram showing an improved fashion collar system; and

FIG. 3 illustrates a high-level flow diagram depicting logical operational steps of an improved fashion collar method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

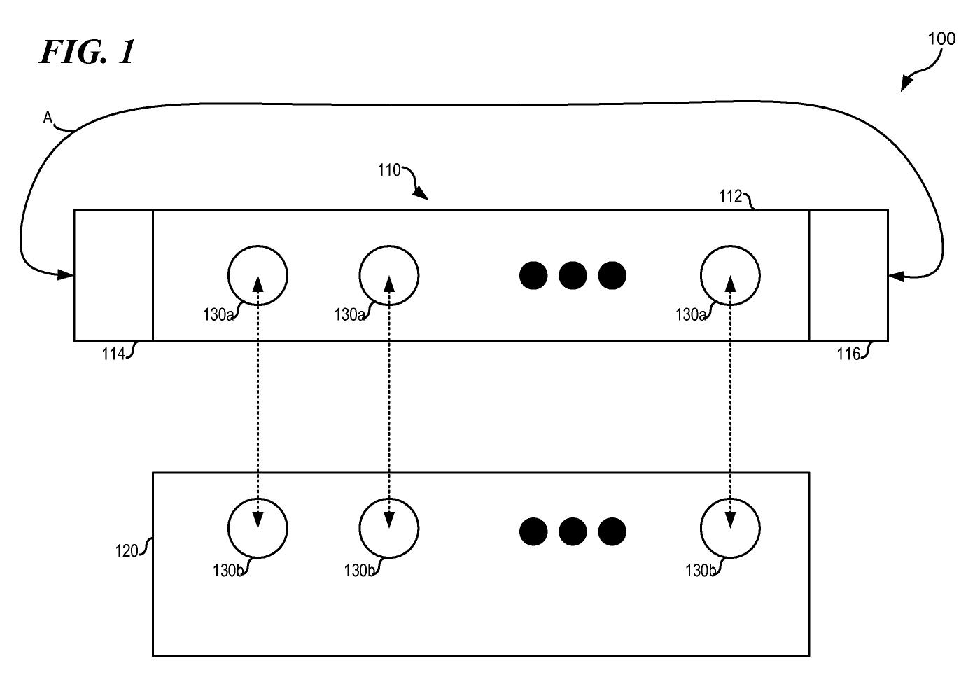

Referring now to the drawings, FIG. 1 is a high-level block diagram illustrating certain components of a system 100 for an improved fashion collar, in accordance with a preferred embodiment of the present invention. System 100 comprises a fashion collar 110 and a fashion attachment 120.

Fashion collar 110 comprises a strip 112, a male buckle 114, and a female buckle 116. Strip 112 comprises durable material suitable for configuration as a collar. Strip 112 comprises, for example, nylon web material, leather, flexible plastic, cotton, other natural fabrics, combinations of flexible plastic and natural or synthetic fabrics or other suitable material.

Male buckle 114 is configured to couple to female buckle 116, as illustrated by double-ended arrow “A”. As such, male buckle 114 and female buckle 116 can comprise a wide variety of coupling systems well known in the art. As used herein, a “buckle” comprises a male buckle and a female buckle. In one embodiment, male buckle 114 and female buckle 116 comprise a plastic tension latch and a strip of material coupled to strip 112. In an alternate embodiment, male buckle 114 and female buckle 116 comprise a loop and tine, and a strip of material including cutouts to receive the tine. In an alternate embodiment, male buckle 114 and female buckle 116 comprise a plastic interconnect with a pressure release configuration.

Strip 112 also includes a plurality of attachment ports 130a. Similarly, fashion attachment 120 also includes a plurality of coupling ports 130b. Generally, attachment port 130a couples to a corresponding coupling port 130b, as indicated by dashed lines. In one embodiment, attachment ports 130a and coupling ports 130b together comprise a metal or plastic stud configured to fit snugly through a hole in the material comprising fashion attachment 120. In an alternate embodiment, attachment ports 130a and coupling ports 130b together comprise a hook and loop coupling. In an alternate embodiment, attachment ports 130a and coupling ports 130b together comprise a snap and button coupling. In an alternate embodiment, attachment ports 130a comprise buttons and coupling ports 130b comprise buttonholes. In an alternate embodiment, attachment ports 130a and coupling ports 130b together comprise a conventional zipper.

In the illustrated embodiment, the attachment ports 130a and coupling ports 130b are arranged in a line along collar 110 and fashion attachment 120. In alternate embodiment, attachment ports 130a and coupling ports 130b can be arranged in a variety of configurations and/or layouts, in a variety of numbers. In one embodiment, attachment ports 130a and coupling ports 130b are configured in aesthetic shapes such as, for example, dog or cat paws, etc.

As such, in operation, one or more attachment ports 130a couple to one or more coupling ports 130b to couple fashion attachment 120 to collar 110. One skilled in the art will appreciate that, so configured, a user can also remove fashion attachment 120 by decoupling the coupling ports 130b from the attachment ports 130a.

Fashion attachment 120 comprises a fashionable accessory in a variety of materials, shapes, and/or colors. For example, in one embodiment fashion attachment 120 comprises a bandana in a pattern. In one embodiment, the pattern comprises one of the following: green camouflage, pink camouflage, decorative gemstones, whether real or costume, rhinestone studs, and other suitable patterns.

In one embodiment, collar 110 is a dog collar. In an alternate embodiment, collar 110 is a cat collar. In an alternate embodiment, collar 110 is configured for human use as a neck collar or armband.

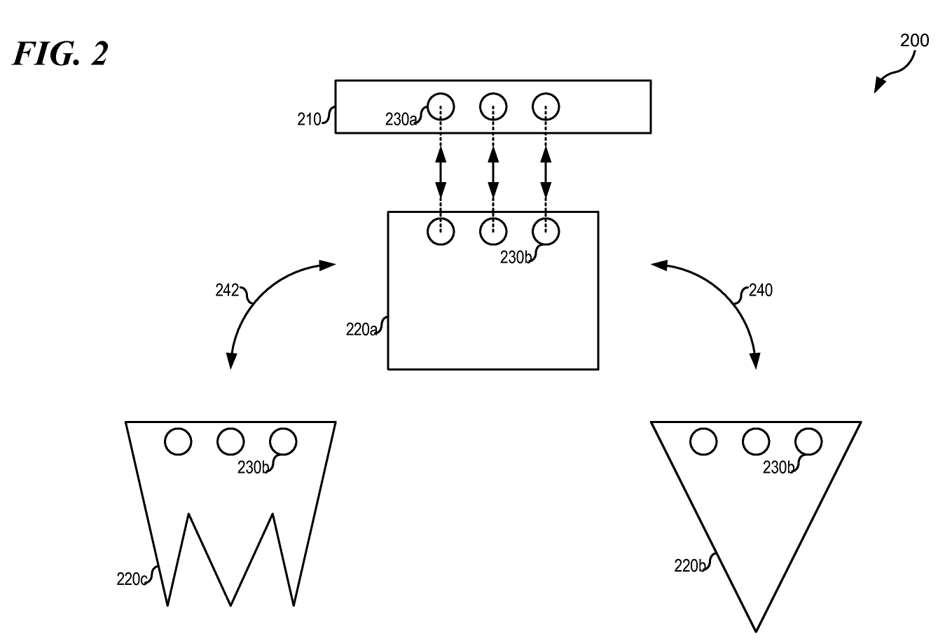

FIG. 2 is a high-level block diagram illustrating certain components of a system 200 for an improved fashion collar, in accordance with a preferred embodiment of the present invention. System 200 comprises a fashion collar 210 and a plurality of fashion attachments 220, designated 220a, 220b, and 220c.

Collar 210 includes a plurality of attachment ports 230a. Each fashion attachment 220 includes a plurality of coupling ports 230b. Generally, coupling ports 230b couple to attachment ports 230a as illustrated by dashed lines between fashion attachment 220a and 210. Collar 210 is configured generally as collar 110 of FIG. 1.

In operation, a user can exchange one fashion attachment 220 for another as desired. For example, a user can decouple fashion attachment 220a from collar 210, and couple fashion attachment 220b to collar 210, as indicated by arrow 240. Similarly, a user can decouple fashion attachment 220a from collar 210, and couple fashion attachment 220c to collar 210, as indicated by arrow 242.

Together fashion attachments 220a, 220b, and 220c represent the numerous and varied fashion accessories that can be configured according to the teachings herein. The particular shapes depicted are for illustrative purposes only and are not to be construed as limiting.

Furthermore, while fashion attachments 220 are generally aesthetic attachments for collar 210, in alternate embodiments, fashion attachments 220 can include various functional features, such as, for example, pockets, (light emitting diode) LED lights, securing clothing that covers other parts of the body, reflective strips, storage pouches, cell phone pouches, key pouches, and other suitable functional features.

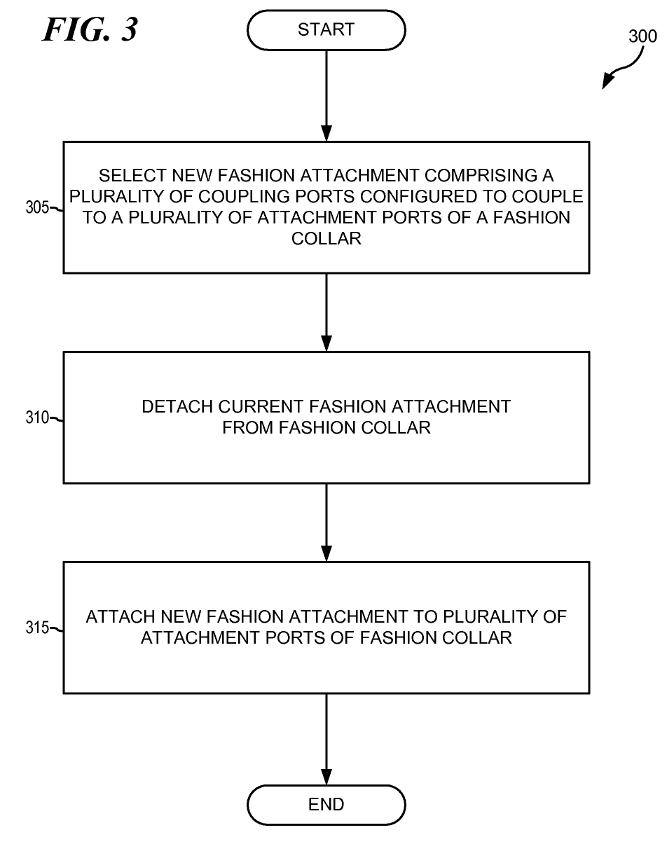

FIG. 3 illustrates one embodiment of a method for providing a customizable fashion collar. Specifically, FIG. 3 illustrates a high-level flow chart 300 that depicts logical operational steps performed in conjunction with, for example, system 200 of FIG. 2, which may be implemented in accordance with a preferred embodiment. Generally, a human user performs the steps of the method, unless otherwise indicated. In one embodiment, the method illustrated provides a customizable dog collar.

As indicated at block 305, the process begins, wherein a human user selects a new fashion attachment. The fashion attachment comprises a plurality of coupling ports configured to couple to a plurality of attachment ports of a fashion collar. For example, in one embodiment, a human user selects fashion attachment 220b of FIG. 2.

Next, as indicated at block 310, the human user detaches the current fashion attachment from a fashion collar. The fashion collar comprises a plurality of attachment ports. For example, in one embodiment, a human user detaches fashion attachment 220a from collar 210 of FIG. 2.

Next, as indicated at block 315, the human user attaches the selected new fashion attachment to the plurality of attachment ports of the fashion collar and the process ends. For example, in one embodiment, a human user attaches fashion attachment 220b to collar 210 of FIG. 2, by coupling coupling ports 230b to attachment ports 230a.

One skilled in the art will appreciate that the human user need not remove the collar from the wearer, if any. Thus, for example, in the embodiment where the collar is a dog collar, the human user can detach and affix the fashion attachments without removing the dog collar from the dog.

Thus, generally, systems 100 and 200 and method 300 provide a convenient method and system for an improved fashion collar that overcomes some of the disadvantages associated with prior art systems and methods.

For example, the novel embodiments disclosed herein allow a human user to exchange fashion accessories on an animal companion collar without requiring the collar be removed. As such, any tags or other attachments coupled to the collar also remain on the collar and need not be removed and reattached to another collar. Additionally, a human user can easily attach lights and/or other reflective safety features. The novel embodiments disclosed herein also provide a method and system to secure costumes to a pet that otherwise would not stay in place, such as, for example, clothing, headbands, capes and other costume accessories. Other advantages will be apparent to one skilled in the art.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A collar, comprising:
a strip of material;
a buckle coupled to the strip of material;
a plurality of attachment ports coupled to the strip of material; and
a fashion attachment comprising a plurality of coupling ports, each coupling port coupled to one of the plurality of attachment ports.

2. The collar of claim 1, wherein:
each attachment port comprises one half of a hook-and-loop coupling; and
each coupling port comprises an other half of a hook-and-loop coupling.

3. The collar of claim 1, wherein:
each attachment port comprises one half of a snap and button coupling; and
each coupling port comprises an other half of a snap and button coupling.

4. A method for customizing an animal companion collar, comprising:
selecting a first fashion attachment comprising a plurality of coupling ports configured to couple to a plurality of attachment ports of a fashion collar;
detaching a second fashion attachment from a first fashion collar, the first fashion collar comprising a plurality of attachment ports; and
attaching the first fashion attachment to the first fashion collar by coupling one or more of the plurality of coupling ports to one or more of the plurality of attachment ports.
